(19) United States
(12) Patent Application Publication
(10) Pub. No.: US 2015/0081447 A1
(43) Pub. Date: Mar. 19, 2015

(54) TRACK DATA POINT-OF-SALE PLATFORM

(71) Applicant: Cortex MCP, Inc., Ladera Ranch, CA (US)

(72) Inventors: Shaunt M. Sarkissian, Ladera Ranch, CA (US); Michael Arner, Albuquerque, NM (US)

(73) Assignee: Cortex MCP, Inc., Ladera Ranch, CA (US)

(21) Appl. No.: 14/031,757

(22) Filed: Sep. 19, 2013

Related U.S. Application Data
(60) Provisional application No. 61/879,705, filed on Sep. 19, 2013.

(51) Int. Cl. G06Q 20/20; G06Q 30/02

(52) U.S. Cl. CPC G06Q 20/204; G06Q 30/0268
USPC 705/14.65; 705/17

(57) ABSTRACT

In various embodiments, the present invention is directed to a computer-implemented method for a track data point-of-sale platform. The computer-implemented method comprises receiving a transaction request by a processor configured to process point-of sale transactions. The transaction request comprises at least one parameter associated with a payment instrument configured for use in the point-of-sale transaction. The computer-implemented method further comprises identifying, by the processor, a transaction request type characterized by an identifier in at least one parameter associated with the payment instrument. The computer-implemented method further comprises processing, by the processor, the transaction request, according to the transaction request type. The computer-implemented method further comprises generating, by the processor, a response to the transaction request.

### CROSS-REFERENCE TO RELATED APPLICATIONS

This application claims benefit under 35 U.S.C. §119(e) of U.S. Provisional Patent Appl. No. 61/879,705, filed on Sep. 19, 2013, entitled “TRACK DATA POINT-OF-SALE PLATFORM,” which is hereby incorporated by reference in its entirety.

### BACKGROUND

The rapid growth and evolution of traditional and electronic commerce markets has resulted in wide-spread demand for monetary payments by digital transactions. Current payment systems at the point of sale are limited by existing devices, infrastructure, and software. Current systems thus limit the ability to process more complex, or entirely different, transactions at the point-of-sale.

Financial transaction cards are a common and prevalent payment instrument at the point of sale. Financial transaction cards may take the form of, but are not limited to, credit cards, debit cards, rewards cards, and/or gifts cards. Financial transaction cards generally, but not exclusively, use a magnetic stripe to store various parameters, such as an account number, the name of the holder of the account, an expiration date, and/or other data. These parameters are generally stored in a standardized format in one or more tracks. At the point of sale, the financial transaction card may be physically and automatically read, such as with a device that reads the magnetic stripe, non-physically and automatically read, such as through Near Field Communication (NFC), or manually entered, such as when a store clerk enters the parameters into a point-of-sale device, or a consumer enters the parameters into a website. The parameters are transmitted to a processing entity, which processes the information and generates a response, indicating how the point-of-sale transaction should be completed. A consumer can thus use a financial transaction card to complete a transaction, such as a purchase, at the point of sale.

The existing infrastructure for use of financial transaction cards and similar payment instruments at the point of sale is ubiquitous. The current system, however, is limited in its ability to process more complex, or entirely different, transactions. Replacing the existing infrastructure with a more flexible system would be expensive and time consuming, and thus not necessarily feasible for all entities who handle point-of-sale transactions.

### SUMMARY

In various embodiments, the present invention is directed to a computer-implemented method for a track data point-of-sale platform. The computer-implemented method comprises receiving a transaction request by a processor configured to process point-of sale transactions. The transaction request comprises at least one parameter associated with a payment instrument configured for use in the point-of-sale transaction. The computer-implemented method further comprises identifying, by the processor, a transaction request type characterized by an identifier in at least one parameter associated with the payment instrument. The computer-implemented method further comprises processing, by the processor, the transaction request, according to the transaction request type. The computer-implemented method further comprises generating, by the processor, a response to the transaction request.

In various embodiments, the present invention is also directed to a computer-implemented method for a track data point-of-sale platform, comprising receiving a transaction request by a first processor. The first processor is configured to process point-of-sale transactions, where the transaction request comprises at least one parameter associated with a payment instrument configured for use in the point-of-sale transaction. The computer-implemented method further comprises identifying, by the first process, a transaction request type characterized by an identifier in at least one parameter associated with the payment instrument. The computer-implemented method further comprises transferring, by the first processor, a transaction request of specified transaction request types to a second processor. The computer-implemented method further comprises processing, by the second processor, the transaction request according to the specified transaction request type. The computer-implemented method further comprises generating, by the second processor, a response to the transaction request. The computer-implemented method further comprises transferring, by the second process, the response to the first processor.

### FIGURES

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIG. 1A illustrates the format of track one data according to ISO/IEC-7813.

FIG. 1B illustrates the format of track two data according to ISO/IEC-7813.

FIG. 1C illustrates the format of track three data according to ISO/IEC-4909.

FIG. 2 illustrates one embodiment of a track data point-of-sale platform.

FIG. 3 illustrates one embodiment of a track data point-of-sale platform.

FIG. 4 illustrates one embodiment of a modified track one data format with a fixed PAN value.

FIG. 5 illustrates one embodiment of a modified track one data format with a fixed PAN value and an optional RCD value in the name field, and additional RCD and offer data.

FIG. 6 illustrates one embodiment of a modified track one data format with a fixed PAN value and an optional RCD value in the discretionary data field, and additional RCD data.

FIG. 7 illustrates one embodiment of a modified track two data format with a fixed PAN value.

FIG. 8 illustrates one embodiment of a modified track two data format with a fixed PAN value and optional RCD values.

FIG. 9 illustrates one embodiment of an intent to spend analytics platform.

FIG. 10 illustrates one embodiment of a computing environment for implementing a track data point-of-sale platform.

### DESCRIPTION

Magnetic Stripe Card Standards

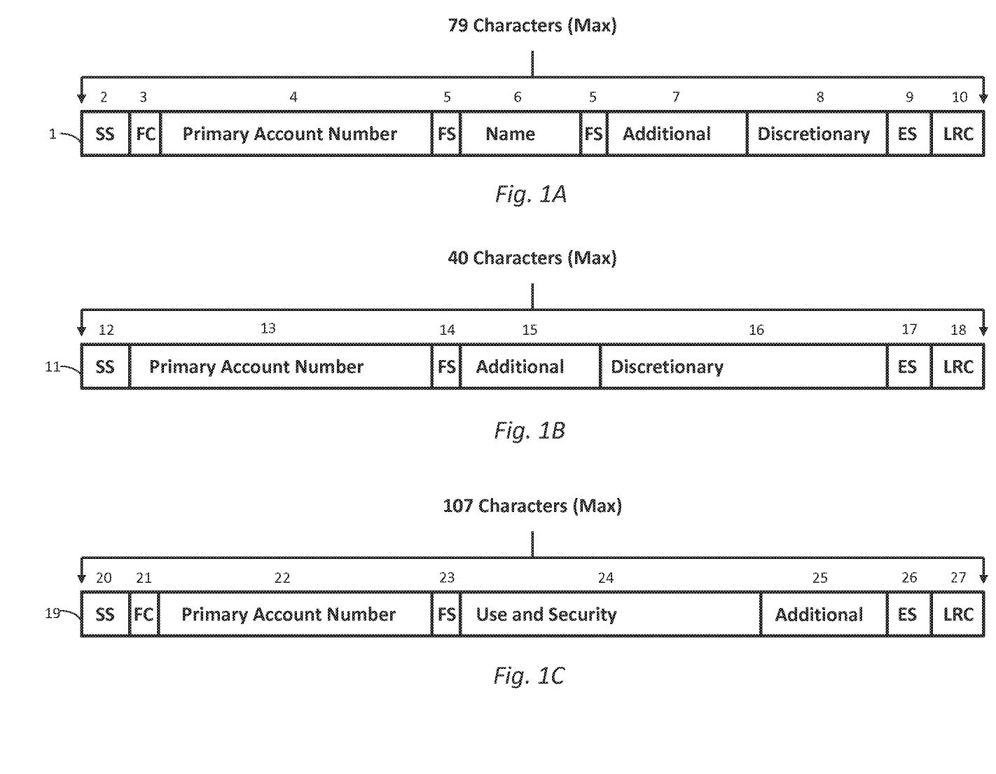

Financial transaction cards are a common and prevalent payment instrument at the point of sale. Financial transaction cards may take the form of, but are not limited to, credit cards, debit cards, rewards cards, or gifts cards. Financial transaction cards generally, but not exclusively, use a magnetic stripe to store various parameters used to complete a point-of-sale transaction. The same parameters may be stored by the financial transaction card in other ways, such as in a microprocessor built into the card. In some embodiments, an issuer of financial transaction cards formats the parameters stored in the magnetic stripe according to, for example, the standards set forth by the International Standards Organization (“ISO”) and the International Electrotechnical Commission (“IEC”). Specifically, the magnetic stripe is divided into three tracks, as illustrated in FIGS. 1A-1B, where tracks one and two are described by ISO/IEC-7813 and track three is described by ISO/IEC-4909, both standards incorporated by reference herein in their entirety. The track formats described herein are based on these standards, however, other formats may be used.

FIG. 1A illustrates one embodiment of the format of track one 1 data, and the parameters stored by track one 1, according to ISO/IEC-7813. In one embodiment, track one 1 stores a maximum of 79 characters, where each character comprises 7 bits. The encoding of the 7-bit characters according to ISO/IEC-7813 is described in TABLE 2 below. A first field in track one 1 comprises the start sentinel 2. In track one 1, the start sentinel comprises the character “%” as defined by TABLE 2 below. A second field comprises a format code 3. The content of the format code 3 field is determined by a party implementing the track one 1 standard. A third field comprises a primary account number 4 (“PAN”). In one embodiment, the PAN has a maximum of 19 characters. The contents of the PAN field is determined by a party implementing the track one 1 standard. A fourth field comprises a field separator 5. In track one 1, the field separator 5 comprises the character “̂” as defined by TABLE 2 below. A fifth field comprises a name data 6. In one embodiment, the name data 6 field has a maximum of 26 characters. A sixth field comprises a field separator 5. A seventh field comprises additional data 7. The additional data 7 may comprise, for example, a four-character expiration date and/or a three-character service code. An eighth field comprises discretionary data 8. The contents of the discretionary data 8 is determined by a party implementing the track one 1 standard. A ninth field comprises an end sentinel 9. In track one 1, the end sentinel comprises the character “?” as defined by TABLE 2 below. A tenth field comprises a longitudinal redundancy check character 10. The longitudinal redundancy check character 10 is used to check for errors in the transmission of the preceding data.

FIG. 1B illustrates one embodiment of the format of track two 11 data, and the parameters stored by track two 11, according to ISO/IEC-7813. In some embodiments, track two 11 stores a maximum of 40 characters, where each character is 5 bits. The encoding of the 5-bit characters according to ISO/IEC-7813 is described in TABLE 3 below. A first field in track two 11 comprises a start sentinel 12. In track two, the start sentinel comprises the character “;” as defined by TABLE 3 below. A second field comprises a PAN 13 (“PAN”). In one embodiment, the PAN comprises a maximum of 19 characters. The contents of the PAN 13 are determined by a party implementing the track two standard. A third field comprises a field separator 14. In track two, the field separator comprises the character “=” as defined by TABLE 3 below. A fourth field comprises additional data 15. The additional data 15 may include, for example, a four-character expiration date and/or a 3-character service code. A fifth field comprises discretionary data 16. The contents of the discretionary data 16 is determined by a party implementing the track two standard. A sixth field comprises an end sentinel 17. In track two 11, the end sentinel 17 comprises the character “?” as defined by TABLE 3 below. A seventh field comprises a longitudinal redundancy check character 18. The longitudinal redundancy check character 18 is used to check for errors in the transmission of the preceding data.

FIG. 1C illustrates one embodiment of the format of track three 19 data, and the parameters stored by track three 19, according to ISO/IEC-4909. In one embodiment, track three 19 stores a maximum of 107 characters, where each character is 5 bits. The encoding of the 5-bit characters according to ISO/IEC-4909 is described in TABLE 3 below. A first field in track three 19 comprises a start sentinel 20. In track three 19, the start sentinel comprises the character “;” as defined by TABLE 3 below. A second field comprises a format code 21. The contents of format code 21 is determined by a party implementing the track three 19 standard. A third field comprises a PAN 22. In one embodiment, the PAN 22 comprises a maximum of 19 characters. The contents of the PAN 22 is determined by a party implementing the track three 19 standard. A fourth field comprises a field separator 23. In track three, the field separator 23 comprises the character “=” as defined by TABLE 3 below. A fifth field comprises use and security data 24. The use and security data may include, for example, any of the fields described in TABLE 1 below. A sixth field comprises additional data 25. The contents of the additional data 25 is determined by a party implementing the track three 19 standard. A seventh field comprises an end sentinel 26. In track three, the end sentinel comprises the character “?” as defined by TABLE 3 below. An eighth field comprises a longitudinal redundancy check character 27. The longitudinal redundancy check character 27 is used to check for errors in the transmission of the preceding data.

TABLE 1 describes one embodiment of various fields that may be present in the use and security data field 24 of track three 19.

TABLE 1

| | | No. of |
|---|---|---|
| Field | Optional? | Characters |
| Country Code | X | 3 |
| Currency Code | | 3 |
| Currency Exponent | | 1 |
| Amount Authorized per Cycle | | 4 |
| Amount Remaining This Cycle | | 4 |
| Cycle Begin (Validity Date) | | 4 |
| Cycle Length | | 2 |
| Retry Count | | 1 |
| PIN Control Parameters | X | 6 |
| Interchange Controls | | 1 |
| PAN Service Restriction | | 2 |
| SAN-1 Service Restriction | | 2 |
| SAN-2 Service Restriction | | 2 |
| Expiration Date | X | 4 |
| Card Sequence No. | | 1 |
| Card Security No. | X | 9 |

TABLE 2 describes one embodiment of a format for characters used by track one 1. This format is set forth by the American National Standards Institute (“ANSI”) and the ISO. The ANSI/ISO ALPHA format uses 7 bits: 6 data bits and 1 parity bit, where parity is calculated as odd. The data is read least significant bit first. The character set contains 64 characters: 43 alphanumeric, 3 framing/field characters, and 18 control/special characters.

TABLE 2

| Data bits | | | | | | | | Value | |
|---|---|---|---|---|---|---|---|---|---|
| b1 | b2 | b3 | b4 | b5 | b6 | b7 | Character | (Hex) | Function |
| 0 | 0 | 0 | 0 | 0 | 0 | 1 | space | 00 | Special |
| 1 | 0 | 0 | 0 | 0 | 0 | 0 | ! | 01 | Special |
| 0 | 1 | 0 | 0 | 0 | 0 | 0 | ″ | 02 | Special |
| 1 | 1 | 0 | 0 | 0 | 0 | 1 | # | 03 | Special |
| 0 | 0 | 1 | 0 | 0 | 0 | 0 | $ | 04 | Special |
| 1 | 0 | 1 | 0 | 0 | 0 | 1 | % | 05 | Start Sentinel |
| 0 | 1 | 1 | 0 | 0 | 0 | 1 | & | 06 | Special |
| 1 | 1 | 1 | 0 | 0 | 0 | 0 | ′ | 07 | Special |
| 0 | 0 | 0 | 1 | 0 | 0 | 0 | ( | 08 | Special |
| 1 | 0 | 0 | 1 | 0 | 0 | 1 | ) | 09 | Special |
| 0 | 1 | 0 | 1 | 0 | 0 | 1 | * | 0A | Special |
| 1 | 1 | 0 | 1 | 0 | 0 | 0 | + | 0B | Special |
| 0 | 0 | 1 | 1 | 0 | 0 | 1 | , | 0C | Special |
| 1 | 0 | 1 | 1 | 0 | 0 | 0 | − | 0D | Special |
| 0 | 1 | 1 | 1 | 0 | 0 | 0 | . | 0E | Special |
| 1 | 0 | 0 | 1 | 0 | 0 | 1 | / | 0F | Special |
| 0 | 0 | 0 | 0 | 1 | 0 | 0 | 0 | 10 | Data |
| 1 | 0 | 0 | 0 | 1 | 0 | 1 | 1 | 11 | Data |
| 0 | 1 | 0 | 0 | 1 | 0 | 1 | 2 | 12 | Data |
| 1 | 1 | 0 | 0 | 1 | 0 | 0 | 3 | 13 | Data |
| 0 | 0 | 1 | 0 | 1 | 0 | 1 | 4 | 14 | Data |
| 1 | 0 | 1 | 0 | 1 | 0 | 0 | 5 | 15 | Data |
| 0 | 1 | 1 | 0 | 1 | 0 | 0 | 6 | 16 | Data |
| 1 | 1 | 1 | 0 | 1 | 0 | 1 | 7 | 17 | Data |
| 0 | 0 | 0 | 1 | 1 | 0 | 1 | 8 | 18 | Data |
| 1 | 0 | 0 | 1 | 1 | 0 | 0 | 9 | 19 | Data |
| 0 | 1 | 0 | 1 | 1 | 0 | 0 | : | 1A | Special |
| 1 | 1 | 0 | 1 | 1 | 0 | 1 | ; | 1B | Special |
| 0 | 0 | 1 | 1 | 1 | 0 | 0 | < | 1C | Special |
| 1 | 0 | 1 | 1 | 1 | 0 | 1 | = | 1D | Special |
| 0 | 1 | 1 | 1 | 1 | 0 | 1 | > | 1E | Special |
| 1 | 1 | 1 | 1 | 1 | 0 | 0 | ? | 1F | End sentinel |
| 0 | 0 | 0 | 0 | 0 | 1 | 0 | @ | 20 | Special |
| 1 | 0 | 0 | 0 | 0 | 1 | 1 | A | 21 | Data |
| 0 | 1 | 0 | 0 | 0 | 1 | 1 | B | 22 | Data |
| 1 | 1 | 0 | 0 | 0 | 1 | 0 | C | 23 | Data |
| 0 | 0 | 1 | 0 | 0 | 1 | 1 | D | 24 | Data |
| 1 | 0 | 1 | 0 | 0 | 1 | 0 | E | 25 | Data |
| 0 | 1 | 1 | 0 | 0 | 1 | 0 | F | 26 | Data |
| 1 | 1 | 1 | 0 | 0 | 1 | 1 | G | 27 | Data |
| 0 | 0 | 0 | 1 | 0 | 1 | 1 | H | 28 | Data |
| 1 | 0 | 0 | 1 | 0 | 1 | 0 | I | 29 | Data |
| 0 | 1 | 0 | 1 | 0 | 1 | 0 | J | 2A | Data |
| 1 | 1 | 0 | 1 | 0 | 1 | 1 | K | 2B | Data |
| 0 | 0 | 1 | 1 | 0 | 1 | 0 | L | 2C | Data |
| 1 | 0 | 1 | 1 | 0 | 1 | 1 | M | 2D | Data |
| 0 | 1 | 1 | 1 | 0 | 1 | 1 | N | 2E | Data |
| 1 | 1 | 1 | 1 | 0 | 1 | 0 | O | 2F | Data |
| 0 | 0 | 0 | 0 | 1 | 1 | 1 | P | 30 | Data |
| 1 | 0 | 0 | 0 | 1 | 1 | 0 | Q | 31 | Data |
| 0 | 1 | 0 | 0 | 1 | 1 | 0 | R | 32 | Data |
| 1 | 1 | 0 | 0 | 1 | 1 | 1 | S | 33 | Data |
| 0 | 0 | 1 | 0 | 1 | 1 | 0 | T | 34 | Data |
| 1 | 0 | 1 | 0 | 1 | 1 | 1 | U | 35 | Data |
| 0 | 1 | 1 | 0 | 1 | 1 | 1 | V | 36 | Data |
| 1 | 1 | 1 | 0 | 1 | 1 | 0 | W | 37 | Data |
| 0 | 0 | 0 | 1 | 1 | 1 | 0 | X | 38 | Data |
| 1 | 0 | 0 | 1 | 1 | 1 | 1 | Y | 39 | Data |
| 0 | 1 | 0 | 1 | 1 | 1 | 1 | Z | 3A | Data |
| 1 | 1 | 0 | 1 | 1 | 1 | 0 | [ | 3B | Special |
| 0 | 0 | 1 | 1 | 1 | 1 | 1 | \ | 3C | Special |
| 1 | 0 | 1 | 1 | 1 | 1 | 0 | ] | 3D | Special |
| 0 | 1 | 1 | 1 | 1 | 1 | 0 | \hat{ } | 3E | Field Separator |
| 1 | 1 | 1 | 1 | 1 | 1 | 1 | _{—} | 3F | Special |

TABLE 3 describes one embodiment of a format for characters used by track two 11 and track three 19. This format is set forth by ANSI and ISO. The ANSI/ISO BCD format is 5 bits: 4 data bits and 1 parity bit, where parity is calculated as odd. The data is read least significant bit first. The character set contains 16 characters: 10 alphanumeric, 3 framing/field characters and 3 control/special characters.

TABLE 3

| Data bits | | | | | | Value | |
|---|---|---|---|---|---|---|---|
| b1 | b2 | b3 | b4 | b5 | Character | (Hex) | Function |
| 0 | 0 | 0 | 0 | 1 | 0 | 00 | Data |
| 1 | 0 | 0 | 0 | 0 | 1 | 01 | Data |
| 0 | 1 | 0 | 0 | 0 | 2 | 02 | Data |
| 1 | 1 | 0 | 0 | 1 | 3 | 03 | Data |
| 0 | 0 | 1 | 0 | 0 | 4 | 04 | Data |
| 1 | 0 | 1 | 0 | 1 | 5 | 05 | Data |
| 0 | 1 | 1 | 0 | 1 | 6 | 06 | Data |
| 1 | 1 | 1 | 0 | 0 | 7 | 07 | Data |
| 0 | 0 | 0 | 1 | 0 | 8 | 08 | Data |
| 1 | 0 | 0 | 1 | 1 | 9 | 09 | Data |
| 0 | 1 | 0 | 1 | 1 | : | 0A | Control |
| 1 | 1 | 0 | 1 | 0 | ; | 0B | Start Sentinel |
| 0 | 0 | 1 | 1 | 1 | < | 0C | Control |
| 1 | 0 | 1 | 1 | 0 | = | 0D | Field Separator |
| 0 | 1 | 1 | 1 | 0 | > | 0E | Control |
| 1 | 1 | 1 | 1 | 1 | ? | 0F | End Sentinel |

Track Data Point-of-Sale Platform

In various embodiments, a computer-implemented method for a track data point-of-sale platform is disclosed. In one embodiment, the computer-implemented method comprises receiving a transaction request by a processor configured to process point-of sale transactions. The transaction request comprises at least one parameter associated with a payment instrument configured for use in the point-of-sale transaction. The computer-implemented method further comprises identifying, by the processor, a transaction request type characterized by an identifier in at least one parameter associated with the payment instrument. The computer-implemented method further comprises processing, by the processor, the transaction request, according to the transaction request type. The computer-implemented method further comprises generating, by the processor, a response to the transaction request.

In various embodiments, a computer-implemented method for a track data point-of-sale platform, comprising receiving a transaction request by a first processor, is disclosed. The first processor is configured to process point-of-sale transactions, where the transaction request comprises at least one parameter associated with a payment instrument configured for use in the point-of-sale transaction. The computer-implemented method further comprises identifying, by the first process, a transaction request type characterized by an identifier in at least one parameter associated with the payment instrument. The computer-implemented method further comprises transferring, by the first processor, a transaction request of specified transaction request types to a second processor. The computer-implemented method further comprises processing, by the second processor, the transaction request according to the specified transaction request type. The computer-implemented method further comprises generating, by the second processor, a response to the transaction request. The computer-implemented method further comprises transferring, by the second process, the response to the first processor.

Reference will now be made in detail to several embodiments, including embodiments showing example implementations of systems and methods for providing a track data point-of-sale platform. Wherever practicable similar or like reference numbers may be used in the figures and may indicate similar or like functionality. The figures depict example embodiments of the disclosed systems and/or methods of use for purposes of illustration only. One skilled in the art will readily recognize from the following description that alternative example embodiments of the structures and methods illustrated herein may be employed without departing from the principles described herein.

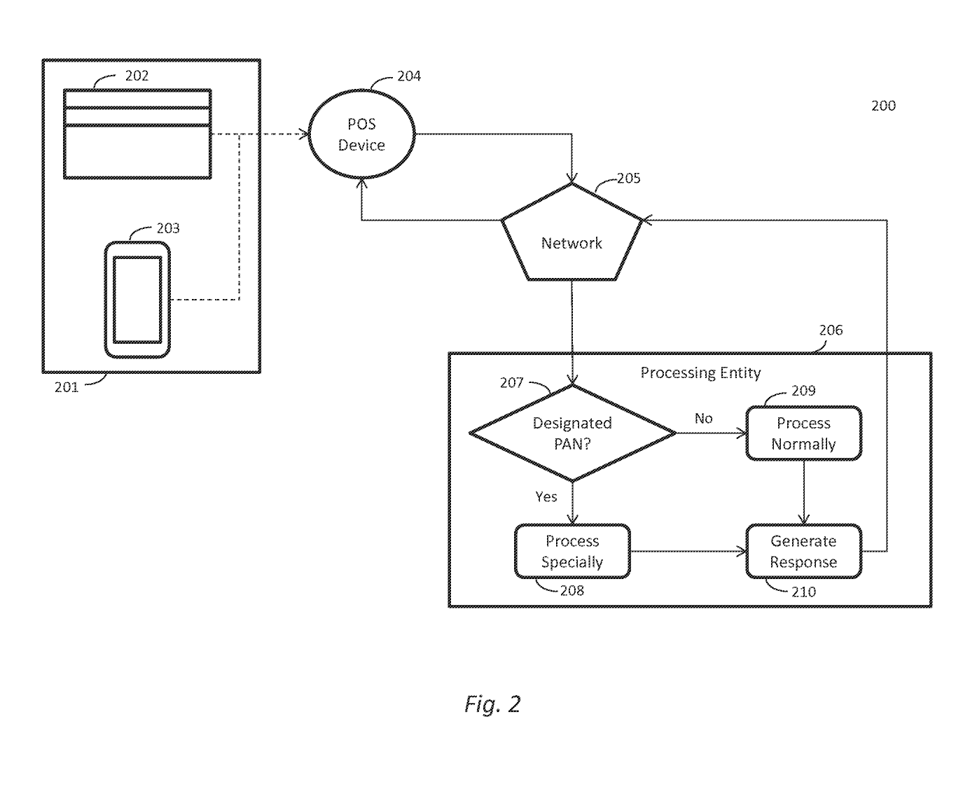

FIG. 2 illustrates one embodiment of a track data point-of-sale platform 200. The track data point-of-sale platform 200 may comprise a payment instrument 201. The track data point-of-sale platform may further comprise a point-of-sale (“POS”) device 204, configured to receive parameters from payment instrument 201. The track data point-of-sale platform 200 may further comprise a network 205, over which the POS device can communicate with a processing entity 206.

In some embodiments, the payment instrument 201 may take the form of a financial transaction card 202 configured with a magnetic stripe containing parameters, such as, for example, according to the Magnetic Stripe Card Standards described above and/or in one or more alternative formats. Financial transaction card 202 may contain similar parameters in another manner, such as, for example, in a microprocessor built into the card. In some embodiments, the payment instrument may take the form of a mobile device 203 capable of generating parameters, such as, for example, according to the Magnetic Stripe Card Standards described above and/or in one or more alternate formats. The financial transaction card 202 and the mobile device 203 payment instruments are merely illustrative, and those skilled in the art will recognize that other payment instruments are possible. In some embodiments, the parameters associated with the payment instrument 201 may be static, that is, may be a fixed set of values, stored in a non-volatile format, such as in a magnetic stripe. In some embodiments, the parameters associated with the payment instrument 201 may be dynamically generated. Dynamically generated parameters may be generated, for example, by a mobile device 203 and stored on the mobile device 203, or may be dynamically generated by the mobile device 203 at the point-of-sale.

In some embodiments, a point-of-sale transaction is initiated at the POS device 204 when the POS device 204 receives a point-of-sale transaction including parameters from a payment instrument 201 and additional information related to the point of sale transaction, such as, for example, a transaction amount and/or a personal identification number (“PIN”). In some embodiments, the POS device 204 may comprise any standard device for reading and/or receiving parameters associated with a payment instrument 201. Such devices include, but are not limited to, magnetic stripe readers, bar code scanners, near field communications (“NFC”) devices, and/or quick response (“QR”) code readers. In some embodiments, a POS device 204 may comprise a general purpose computer executing software that executes point-of-sale transactions, such as a computer programmed to display and interact with webpages. The POS device 204 may receive parameters from the payment instrument 201 either by physically and automatically reading the parameters from the payment instrument 201, such as happens when a financial transaction card is read by a magnetic stripe reader, non-physically and automatically reading parameters, such as through a NFC transaction, or by manual entry, such as when a clerk enters the parameters into the POS device 204 with a keypad attached to the POS device 204, or such as when a consumer enters the parameters into a website.

Upon receiving a point-of-sale transaction, the POS device 204 transmits the point-of-sale transaction to a network 205. The network 205 may comprise any standard network infrastructure, such as but not limited to telephone lines, Ethernet cables, optical fibers, the internet, associated equipment, and/or any other suitable network.

In some embodiments, the POS device 204 transmits the point-of-sale transaction over the network 205 to a processing entity 206. The processing entity 206 verifies the parameters from the payment instrument 201 and determines how the point-of-sale transaction should be completed. In various embodiments of the track data point-of-sale platform, processing entity 206 receives parameters from the payment instrument 201 over the network 205, including a primary account number (“PAN”), described above. In various embodiments of the track data point-of-sale platform, specific PANs identify a transaction request type. Certain transaction types will be designated for special processing 208. Transaction types that are not designated for special processing 208 are processed normally 209 by the processing entity 206. Some transaction types may be processed both normally 209 and specially 208.

In normal processing 209, the processing entity generally determines how the point-of-sale transaction should be completed. In special processing 208, processing entity 206 may take certain steps, described in further detail below, instead of or in addition to determining how the point-of-sale transaction should be completed. Special processing 208 allows point-of-sale transactions to implement more complex, or entirely different, transactions than are possible without special processing 208. The result of either special processing 208 or normal processing 209 is used to generate a response 210. The response 210 is transmitted over the network 205 to the POS device 204 that originated the point-of-sale transaction. The response 210 is formatted in a manner readily understood by POS device 204. In some embodiments, a response 210 sent after special processing 208 may use some fields in the response 210 to return supplementary information in existing fields that have been assigned new meaning. Upon receipt of the response, POS device 204 completes the point-of-sale transaction.

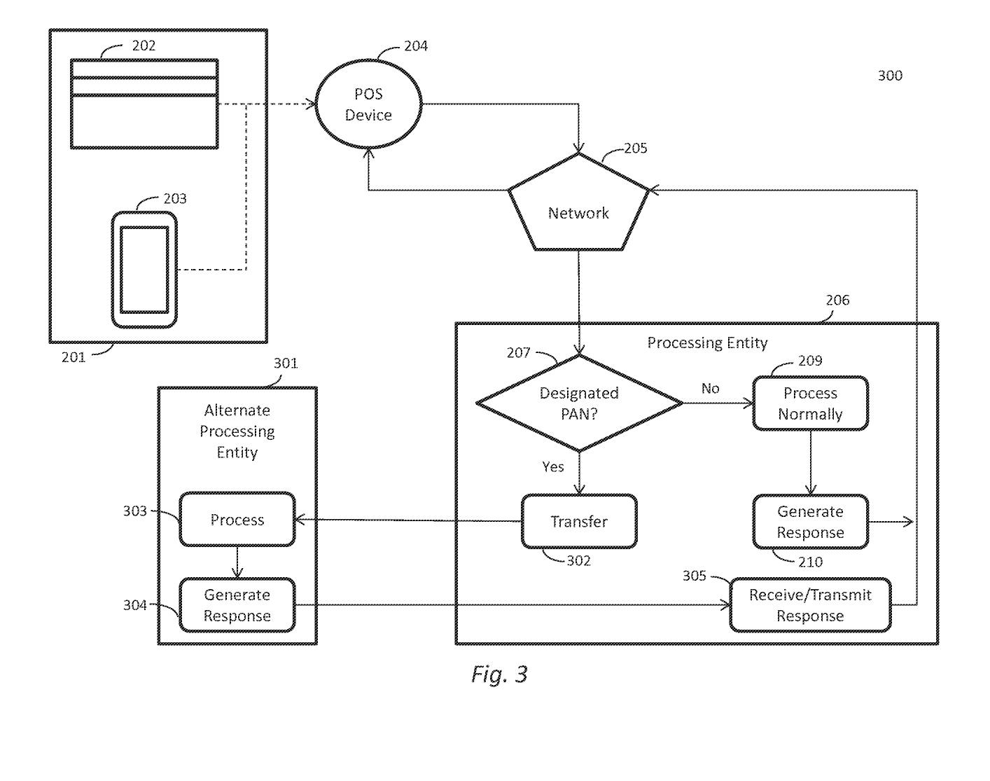

FIG. 3 illustrates one embodiment of a track data point-of-sale platform 300. The track data point-of-sale platform 300 may comprise a payment instrument 201, a POS device 204, a network 205, a processing entity 206, and an alternate processing entity 301.

A point-of-sale transaction is initiated at the POS device 204 when the POS device 204 receives a point of sale transaction, including parameters from the payment instrument 201. Upon receiving the point-of-sale transaction, the POS device 204 transmits a point-of-sale transaction over the network 205 to the processing entity 206. The processing entity 206 determines the transaction type using the PAN parameter from the payment instrument 201. Transactions of certain types are designated for normal processing 209, or for transfer 302. If a transaction type is designated for normal processing 209, then the processing entity 206 executes normal processing, and determines how the point-of-sale transaction should be completed. If a transaction type is designated for transfer 302, then the processing entity 206 transfers the point-of-sale transaction and its associated parameters to an alternate processing entity 301. In processing 303 the point-of-sale transaction, the alternate processing entity 301 may take certain steps, described in further detail below, instead of or in addition to determining how the point-of-sale transaction should be completed. Once the additional and/or alternative steps are completed, the alternate processing entity 301 generates a response 304 for the point-of-sale transaction and transfers this response 304 to the processing entity 206. The processing entity 206 receives the response 304 and transmits 305 the response 304 over the network 205 to the POS device 204 that initiated the point-of-sale transaction.

It should be understood that the above descriptions are merely illustrative of possible embodiments of a track data point-of-sale platform. One skilled in the art will recognize that alternate embodiments are possible, such as, but not limited to, transferring a point-of-sale transaction to a second or third alternate processing entity, and receiving responses from each. The alternative embodiments are intended to be within the scope of this disclosure and the attached claims.

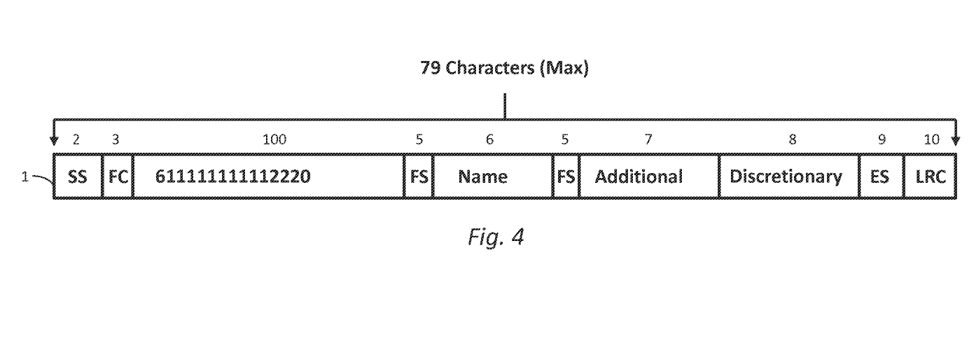

In one embodiment, the special processing illustrated in FIGS. 2-3 above is made possible by associating one or more PANs with transaction types. For example, certain transaction types designate that a point-of-sale transaction should receive special processing. FIG. 4 illustrates one embodiment of a modified ISO/IEC-7813 track one 1 format that uses the PAN field 100 to designate the transaction type. Typically, PAN field 100 stores an account number, and is used by the processing entity 206 to identify the account that should be accessed to satisfy the point-of-sale transaction. In FIG. 4, the value in the PAN field 100 has been replaced with a fixed value, here illustrated as “611111111112220”. In this example, all remaining fields in the track one 1 data are unchanged. By using a fixed value in the PAN field 100, the account information normally located in the PAN field is removed, thus allowing the fixed value to be used with multiple payment instruments. The fixed value in the PAN field 100 alerts the processing entity 206 that the point-of-sale transaction associated with the track one 1 parameters is of a type that should be specially processed. Using a fixed value in the PAN field 100 to identify the transaction type is one example of an embodiment that uses the PAN field to identify transaction types. Alternate embodiments comprise partially fixed values and non-fixed values. It should also be recognized that the ISO/IEC-7813 track one format is merely one format for parameters associated with a payment instrument. Other formats are within the scope of the present disclosure, and one or more additional and/or alternative fields can be used to identify transaction types.

The special processing that is triggered by designated transaction types may involve any number of steps. For example, in one embodiment, the point-of-sale transaction may be processed using a different funding source than would be used with normal processing. Examples of such funding sources include, but are not limited to, an alternate credit card processor, an automated clearing house (“ACH”), a frequent flier miles account, a rewards card, a reducing currency denomination payment instrument, and/or any other alternative payment instrument. In other embodiments, special processing comprises subjecting the point-of-sale transaction to approval from an alternate party or subjecting the point-of-sale transaction to pre-defined limits, as described below. In other embodiments, special processing comprises modifying a transaction amount associated with the point-of-sale transaction, and/or optionally including an offer or penalty with the response returned to the POS device.

For example, in one embodiment, a point-of-sale transaction is received by the processing entity 206. The PAN field of the received point-of-sale transaction indicates that the received transaction requires special processing. The processing entity 206 provides the point-of-sale transaction to an alternative processing entity 301 for special processing. The alternative processing entity 301 may identify one or more offers associated with a payment instrument, such as, for example, a reducing currency denomination (RCD) instrument, identified by the track data received in the point-of-sale transaction. A special offer may, for example, reduce the price of the point-of-sale transaction. The alternative processing entity 301 approves a partial transaction amount and, in the response returned to the POS device 204, includes an indication that one or more offers have been applied. The modified response may alert the operator of the POS device that the point-of-sale transaction has been satisfied by a partial transaction amount and an offer, such as but not limited to a coupon, reward points, or stored credits, which the operator can then accept.

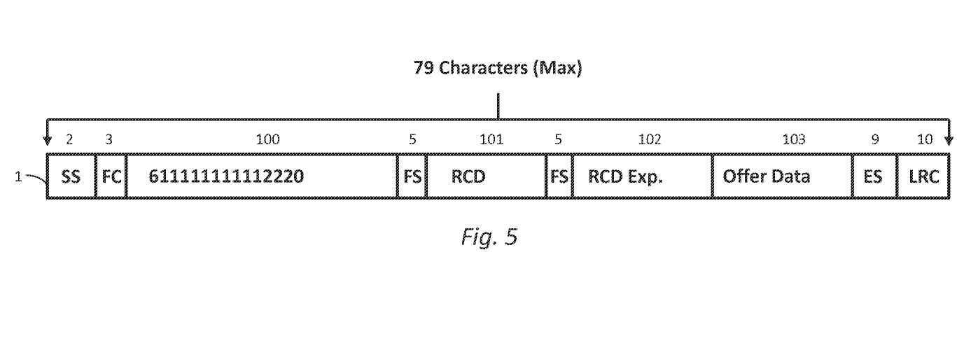

In some embodiments, special processing is directed to process generated payment instruments, such as, for example, a reducing currency denomination (“RCD”) payment instrument. A RCD payment platform is described in more detail in U.S. Patent App. Pub. No. 2009/0070268, entitled “SYSTEMS, METHODS, AND APPARATUSES FOR SECURE DIGITAL TRANSACTIONS,” published on Mar. 12, 2009, the disclosure of which is herein incorporated by reference in its entirety. FIG. 5 illustrates one embodiment of a modified track one 1 format that includes RCD data for transmission to a processing entity 206 and/or alternate processing entity 301. In FIG. 5, the value name field 101 has been replaced with an RCD value. As in FIG. 4, the PAN field 100 contains a value that identifies a transaction type. All remaining fields in the track one 1 data are unchanged, except as described below. By placing the RCD value in the name field 101, the RCD will be transmitted for processing along with all the other parameters in the track one 1 data. The value in the PAN field 100 designates the point-of-sale transaction that includes modified track one 1 parameters according to FIG. 5 as requiring special processing, including optionally using the RCD value 101 as part of the processing.

In some embodiments, an RCD is associated with additional data, for example an expiration date and offer data. FIG. 5 further illustrates optionally modifying the track one 1 format to place the RCD expiration value in the additional data field 102. Offer data, which is used described in further detail below, may optionally be placed in the discretionary data field 103.

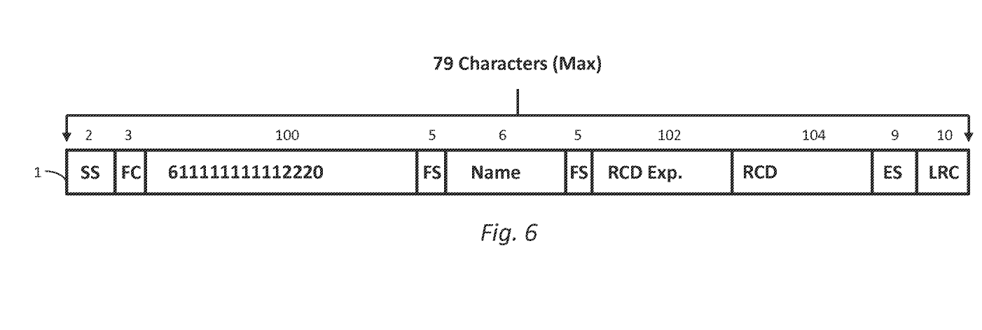

FIG. 6 illustrates another embodiment of a modified track one 1 format that includes an RCD value. In FIG. 6, the RCD value has been placed in discretionary data field 104. An optional RCD expiration date may be placed in additional data field 102. As in FIG. 4, the PAN field 100 contains a value that identifies a transaction type. All remaining fields in the track one 1 data are unchanged. The value in the PAN field 100 designates the point-of-sale transaction that includes modified track one 1 parameters according to FIG. 6 as requiring special processing, including optionally using the RCD 104 as part of the processing.

For example, in one embodiment, the PAN field 100 indicates that the payment information received by a processing entity 206 comprises an alternative payment method. The PAN field 1000 may, for example, identify an RCD payment type. The processing entity 206 identifies the payment information as requiring special processing and forwards the payment information to, for example, a third-party RCD processing platform. The third party RCD processing platform processes the RCD transaction utilizing RCD information stored in one or more additional fields of the payment information, such as, for example, the discretionary data field 104, the additional data field 102, and/or any other field of the payment information. The third party RCD processing platform processes the transaction and provides a response 304 that the transaction was successful to the processing entity 206. The processing entity transmits the response 304 to the POS-platform, which completes the transaction.

It should be understood that the above descriptions are merely examples of embodiments modifying the ISO/IEC-7813 track one format to associate point-of-sale transactions with transaction types, and to transmit optional generated payment instruments and their associated data to a processing entity. One skilled in the art will recognize that alternate embodiments are possible.

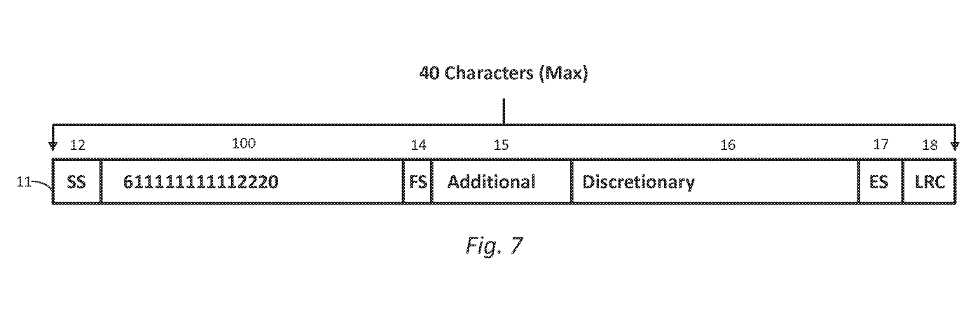

FIG. 7 illustrates one embodiment for associating specific PANs with transaction types. The embodiment illustrated in FIG. 7 modifies the ISO/IEC-7813 track two 11 format. In this embodiment, the value in the PAN field 100 has be replaced with a fixed value, here illustrated as “611111111112220”. Although a specific fixed value has been illustrated, those skilled in the art will recognize that any suitable fixed value may be used in the PAN field 100. In this example, all remaining fields in the track two 11 data are unchanged. The fixed value in the PAN field 100 alerts the processing entity 206 that the point-of-sale transaction associated with the track two 11 parameters is of a type that should be specially processed.

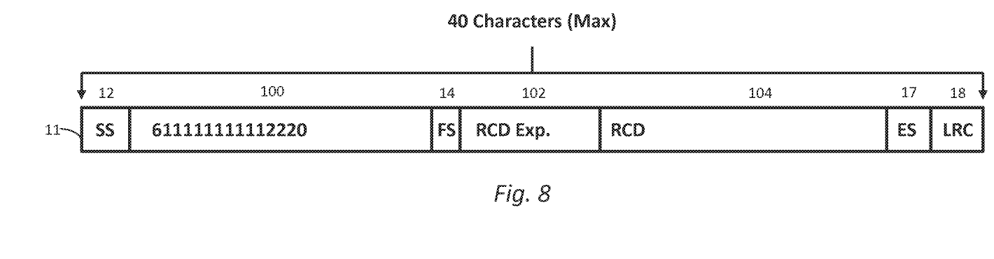

Special processing may additionally be directed to process generated payment instruments, such as, for example, an RCD payment instrument. FIG. 8 illustrates one embodiment of a modified track two 11 format that includes RCD data for transmission to a processing entity 206 and/or alternate processing entity 301. In FIG. 8, the RCD data is placed in the discretionary data field 104. An RCD may optionally be associated with an expiration date. As illustrated in FIG. 8, the RCD expiration data may optionally be placed in the additional data field 102.

It should be understood that the above descriptions are merely examples of embodiments modifying the ISO/IEC-7813 track two format to associate point-of-sale transactions with transaction types, and to transmit optional generated payment instruments and their associated data to a processing entity. One skilled in the art will recognize that alternate embodiments are possible. Although embodiments describing track one and track two data have been disclosed, those skilled in the art will recognize that any other suitable standards and/or payment formats may be utilized with the present disclosure. For example, in one embodiment, one or more fields of the track three data discussed with respect to FIG. 1C may be replaced with RCD payment information.

Intent to Spend Analytics

Special processing described above may optionally include an embodiment of an intent to spend analytics platform. An intent to spend analytics platform is described in more detail in U.S. patent application Ser. No. 13/834,763, entitled “INTENT TO SPEND ANALYTICS PLATFORM,” filed Mar. 15, 2013, the disclosure of which is herein incorporated by reference in its entirety.

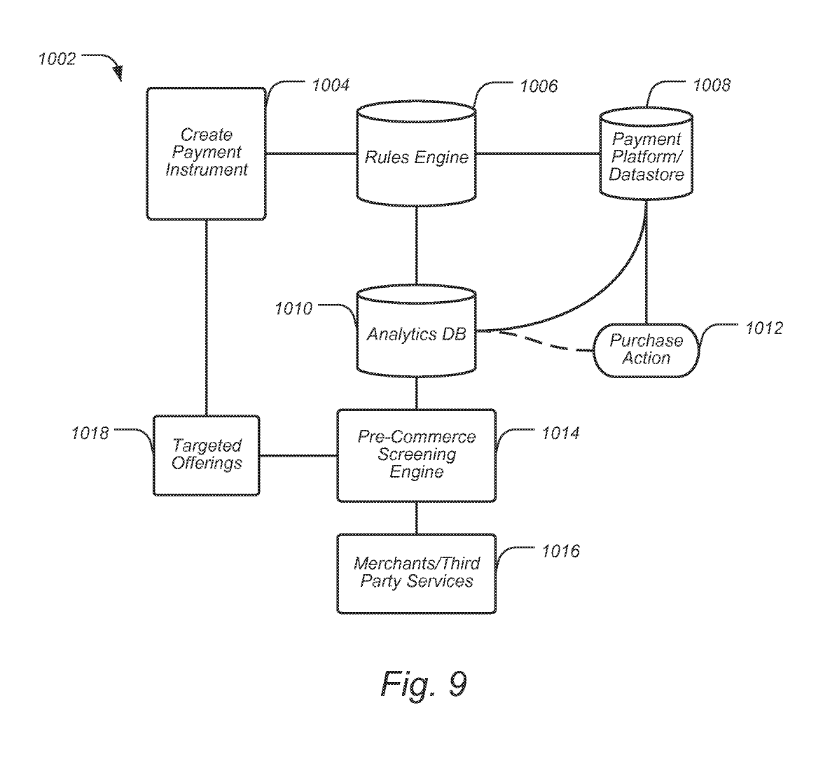

FIG. 9 illustrates one embodiment of an intent to spend analytics platform 1002. The intent to spend analytics platform 1002 may be configured to generate user-generated payment instruments 1004, such as, for example, an RCD payment instrument. The intent to spend analytics platform 1002 may generate user-generated payment instrument 1004 from any suitable source, such as, for example, by charging a credit card, debiting a bank account, accessing a gift card balance, points in a loyalty club account, and/or receiving a payment instrument from a third party.

The intent to spend analytics platform 1002 may comprise a rules engine 1006. The rules engine 1006 may be configured to generate one or more parameters or rules for a user-generated payment instrument 1004. The parameters may define the user-generated payment instrument 1004, such as, for example, by defining a value of the user-generated payment instrument 1004. The parameters may comprise one or more rules to limit the user-generated payment instrument 1004 to specific uses as described by the one or more rules. For example, in one embodiment, the rules engine 1006 may generate one or more rules for a user generated payment instrument, such as: a limited total value of a single transaction; a limited total value of a plurality of transactions; a limited number of transactions per day; an expiration date; limiting the user generated payment instrument to a specific category of merchants; and/or limiting the user generated payment instrument to a specific set of merchants, for example, one or more merchants.

In one embodiment, the rules engine 1006 may generate a user-generated payment instrument 1004 having a parameter defining a set total value. When the user-generated payment instrument 1004 has been used to purchase goods up to the set total value, the user-generated payment instrument 1004 may be deactivated or may be removed from a user platform, for example, a virtual wallet platform. For example, the rules engine 1006 may generate a parameter of a user-generated payment instrument 1004 with a set value of $100. When the user-generated payment instrument 1004 has been used to pay for goods totaling $100, the user-generated payment instrument 1004 may be deactivated and no additional payments may be made using the user-generated payment instrument 1004.

In one embodiment, the rules engine 1006 may generate a parameter limiting a user generated payment instrument to a maximum transaction value of a single transaction. The user-generated payment instrument 1004 may be limited to transactions less than the maximum transaction value. In some embodiments, a user may be unable to use the user-generated payment instrument 1004 in any transaction exceeding the limited value. In some embodiments, the user may be able to use the user-generated payment instrument 1004 up to the limited value and may provide a second payment instrument for the value exceeding the maximum transaction value of the user generated payment instrument. For example, in one embodiment, a user-generated payment instrument 1004 may be limited to a total transaction value of $50.00. If a user attempts to use the user-generated payment instrument 1004 for a transaction more than the maximum transaction value, for example, $60.00, the user may be limited to only the maximum transaction value limit of $50.00 and would need to provide a second form of payment, such as, for example, a second user generated payment instrument, for the remaining balance. As another example, the user may be unable to use the user-generated payment instrument 1004 for the $60.00 transaction, as the transaction exceeds the maximum transaction value of the user-generated payment instrument 1004.

In some embodiments, the rules engine 1006 may generate a parameter limiting a user-generated payment instrument 1004 to a maximum number of transactions per day. The user-generated payment instrument 1004 may only be used to make a certain number of transactions up to the maximum number of transactions per day. For example, a user-generated payment instrument 1004 may be limited to a maximum of five transactions per day. If a user attempts to use the user-generated payment instrument 1004 to make a sixth payment, the rule will prevent the use of the user-generated payment instrument 1004.

In some embodiments, the rules engine 1006 may generate a parameter limiting a user-generated payment instrument 1004 to a specific time limit, such as, for example, by assigning an expiration date. The user-generated payment instrument 1004 may have to be used by the expiration date or else the balance of the user-generated payment instrument 1004 may be lost or revert back to the original source of the funds. In some embodiments, the rules engine 1006 may generate a parameter limiting a user-generated payment instrument 1004 to one or more specific merchants or merchant categories. For example, a user-generated payment instrument 1004 may be limited to a specific type of merchant, such as, for example, grocery stores. As another example, a user generated payment instrument may be limited to use at a specific retailer, such as, for example, a specific grocery store chain. Although various parameters have been described above, those skilled in the art will recognize that the rules engine 1006 may generate any suitable parameter for defining and/or limiting the use of a user generated payment instrument.

After generating one or more parameters for the user-generated payment instrument 1004, the intent to spend analytics platform 1002 may store the user-generated payment instrument 1004. A payment platform 1008, for example, a virtual wallet platform or a payment database, may store one or more user-generated payment instruments 1004. In some embodiments, the payment platform 1008 may comprise a payment platform executed by a user device, such as, for example, virtual wallet platform executed by a user mobile device. In some embodiments, the payment platform 1008 may comprise a payment database configured to store one or more user-generated payment instruments 1004 and accessible over a communication network, such as, for example, the Internet. The payment platform 1008 may store the one or more user-generated payment instruments 1004 as well as the one or more parameters generated for each user-generated payment instrument 1004. The payment platform 1008 may store additional information for each user-generated payment instrument 1004, such as, for example, a current balance, usage history, or targeted offers associated with the user-generated payment instrument 1004.

In some embodiments, the rules engine 1006 and/or the payment platform 1008 may be in communication with an analytics datastore 1010, such as, for example, a database. The analytics datastore 1010 may be configured to store the parameters generated by the rules engine and/or information about the user-generated payment instruments 1004 stored in the payment platform 1008. In some embodiments, the analytics datastore 1010 may store user information regarding purchase history, previous purchases, and/or other relevant analytical information associated with one or more users. In some embodiments, the analytics datastore 1010 may receive data from one or more purchase actions 1012, such as, for example, the merchant, class of merchant, amount, time, and/or type of purchase made using a payment instrument. The purchase action may be associated with a specific targeted offer 1018 received by a user. The analytics datastore 1010 may receive information related to a targeted offer 1018 and may generate analytical information related to the targeted offer 1018, such as, for example, a success rate of the targeted offer 1018.

The analytics datastore 1010 may be accessible by a pre-commerce screening engine 1014. The pre-commerce screening engine 1014 may be configured to access the analytics datastore 1010 and generate one or more targeted offers 1018. A targeted offer 1018 may comprise an offer generated by a merchant 1016 accessing the pre-commerce screening engine 1014 that matches one or more parameters for a user-generated payment instrument 1004 and/or analytical data corresponding to one or more users. For example, in one embodiment, a user-generated payment instrument 1004 may be limited to a specific class of merchants. A merchant 1016 within the class of merchants may receive information from the analytics datastore 1010 indicating that a user-generated payment instrument 1004 exists that is limited to the merchant's 1016 class. The merchant 1016 may access the pre-commerce screening engine 1014 to generate an offer, such as an advertisement, to be sent to one or more users having payment instruments limited to the merchant class of the merchant.

In some embodiments, the pre-commerce screening engine 1014 may provide screened data to one or more merchants/third party services 1016. Screened data may comprise analytical data that has had user personal information removed from the data. For example, the pre-commerce screening engine 1014 may provide screened data without providing user names, locations, financial information, and/or other personal and/or sensitive information. In some embodiments, the analytics datastore 1010 and/or the pre-commerce screening engine 1014 may comprise one or more anonymous screening filters configured to screen the data contained in the analytics datastore 1010 to ensure user privacy while still providing enough information to generate relevant offers and analytical data. Merchants 1016 (or other third-party services) may access the pre-commerce screening engine 1014 to generate one or more offers based on the anonymous user data provided by the analytics datastore 1010. In some embodiments, the screened data may add filters defined by the user, for example, to remove offers by merchants, merchant categories, price ranges, date ranges, number of offers within a category or timeframe, payment mechanisms, or other types of offer attributes.

The merchants and/or third-party services 1016 may access the data provided by the analytics datastore 1010 through the pre-commerce screening engine 1014 to generate one or more targeted offers 1018. As discussed above, a targeted offer 1018 may comprise an offer sent to one or more users meeting a specific criteria, such as, for example, users having a payment instrument 1004 limited to a specific class of merchants or a user with a history of transactions at a specific merchant. Targeted offers 1018 may be delivered by the intent to spend analytics platform 1002 to a user, such as, for example, by sending a targeted offer 1018 to one or more user devices. In one embodiment, a user may opt-in to receive targeted offers 1018 from the intent to spend analytics platform 1002. For example, in some embodiments, a user may access a virtual wallet platform on a user device and may access available targeted offers 1018 directed to the user. In some embodiments, one or more targeted offers 1018 may be stored in by the payment platform 1008 and may be presented to a user when the user accesses a payment instrument through the payment platform 1008. A user may choose to use a payment instrument at a specific merchant or third party service based on the targeted offers 1018. In some embodiments, the pre-commerce screening engine 1014 may allow merchants 1016 to analyze the buying history of one or more users and the effectiveness of targeted offers 1018 directed to the one or more users.

In some embodiments, the analytics datastore 1010 may receive and store data indicating the success of targeted offers 1018 generated by one or more merchants. For example, the analytics datastore 1010 may receive data indicating that a user viewed a targeted offer for a specific merchant 1016 and subsequently engaged in a transaction with the merchant 1016 using a payment instrument. The analytics datastore 1010 may receive the details of the targeted offer 1018 delivered to the user and may indicate the targeted offer 1018 was a successful offer for one or more users. In some embodiments, the analytics datastore 1010 may store purchase information for one or more users unrelated to a targeted offer 1018. For example, the analytics datastore 1010 may periodically receive all purchase activity for a user. The purchase activity may be provided to the pre-commerce screening engine 1014 for generating or matching targeted offers 1018 to the user.

In some embodiments, the pre-commerce screening engine 1014 may provide analytical information to one or more merchants/third-party services 1016 identifying a success or failure rate of targeted offers. For example, the pre-commerce screening engine 1014 may provide information indicating the number of targeted offers 1018 sent by the merchant 1016, the number of users that received the targeted offers 1018, and the number of users that subsequently engaged in a transaction with the merchant 1016. The merchant 1016 may use the analytical information related to the success or failure of one or more targeted offers 1018 to generate targeted offers 1018 that are statistically more likely to be successful.

In some embodiments, the pre-commerce screening engine 1014 may store a targeted offer 1018 generated by a merchant 1016. The pre-commerce screening engine 1014 may identify users or payment instruments that match the criteria of the targeted offer 1018 but that have not receive the targeted offer 1018, for example, because the payment instrument was generated after the targeted offer 1018 was generated by the pre-commerce screening engine 1014. The pre-commerce screening engine 1014 may automatically transmit the targeted offer 1018 to the identified user or payment instruments that match the targeted offer 1018 criteria but have not previously received the targeted offer 1018.

In some embodiments, the analytical datastore 1010 and/or the pre-commerce screening engine 1014 may provide analytical data to merchants 1016 identifying one or more users who have generated user generated payment instruments. For example, the pre-commerce screening engine 1014 may identify a user who generates multiple user generated payment instruments 1004 for a specific class of merchants. A merchant 1016 may receive analytical information about the user and may use the pre-commerce screening engine 1014 to generate one or more targeted offers 1018 for the user. The one or more targeted offers 1018 may provide an incentive to the user to create user generated payment instruments limited to, for example, a specific merchant within the class of merchants, a narrower class of merchants, or a different class of merchants.

Computing Device

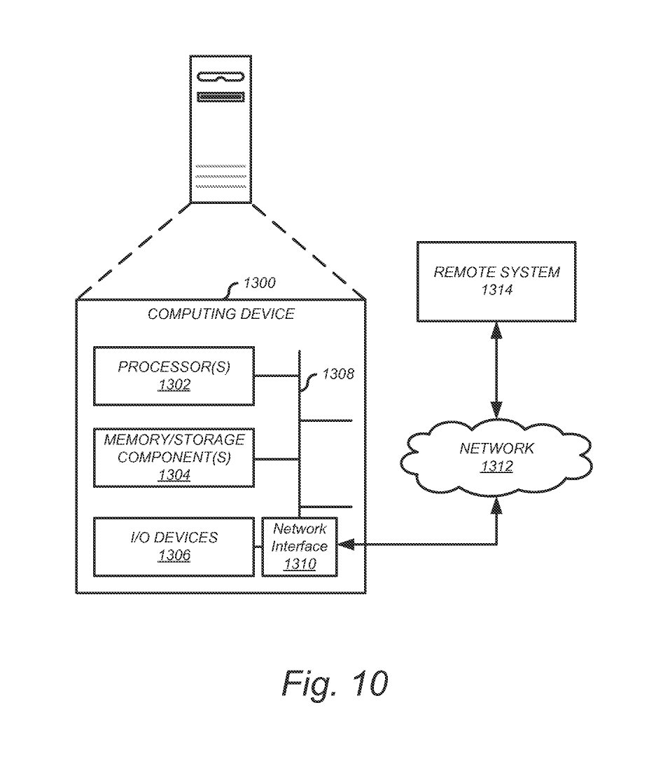

FIG. 10 illustrates one embodiment of a computing device 1300 which can be used in one embodiment of the system and method for track data point-of-sale platform. For the sake of clarity, the computing device 1300 is shown and described here in the context of a single computing device. It is to be appreciated and understood, however, that any number of suitably configured computing devices can be used to implement any of the described embodiments. For example, in at least some implementation, multiple communicatively linked computing devices are used. One or more of these devices can be communicatively linked in any suitable way such as via one or more networks (LANs), one or more wide area networks (WANs) or any combination thereof.

In this example, the computing device 1300 comprises one or more processor circuits or processing units 1302, one or more memory circuits and/or storage circuit component(s) 1304 and one or more input/output (I/O) circuit devices 1306. Additionally, the computing device 1300 comprises a bus 1308 that allows the various circuit components and devices to communicate with one another. The bus 1308 represents one or more of any of several types of bus structures, including a memory bus or local bus using any of a variety of bus architectures. The bus 1308 may comprise wired and/or wireless buses.]

The processing unit 1302 may be responsible for executing various software programs such as system programs, applications programs, and/or module to provide computing and processing operations for the computing device 1300. The processing unit 1302 may be responsible for performing various voice and data communications operations for the computing device 1300 such as transmitting and receiving voice and data information over one or more wired or wireless communication channels. Although the processing unit 1302 of the computing device 1300 includes single processor architecture as shown, it may be appreciated that the computing device 1300 may use any suitable processor architecture and/or any suitable number of processors in accordance with the described embodiments. In one embodiment, the processing unit 1302 may be implemented using a single integrated processor.

The processing unit 1302 may be implemented as a host central processing unit (CPU) using any suitable processor circuit or logic device (circuit), such as a as a general-purpose processor. The processing unit 1302 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 1302 may be coupled to the memory and/or storage component(s) 1304 through the bus 1308. The memory bus 1308 may comprise any suitable interface and/or bus architecture for allowing the processing unit 1302 to access the memory and/or storage component(s) 1304. Although the memory and/or storage component(s) 1304 may be shown as being separate from the processing unit 1302 for purposes of illustration, it is worthy to note that in various embodiments some portion or the entire memory and/or storage component(s) 1304 may be included on the same integrated circuit as the processing unit 1302. Alternatively, some portion or the entire memory and/or storage component(s) 1304 may be disposed on an integrated circuit or other medium (e.g., hard disk drive) external to the integrated circuit of the processing unit 1302. In various embodiments, the computing device 1300 may comprise an expansion slot to support a multimedia and/or memory card, for example.

The memory and/or storage component(s) 1304 represent one or more computer-readable media. In some embodiments, the computer-readable media may comprise non-transitory computer readable-media. The memory and/or storage component(s) 1304 may be implemented using any computer-readable media capable of storing data such as volatile or non-volatile memory, removable or non-removable memory, erasable or non-erasable memory, writeable or re-writeable memory, and so forth. The memory and/or storage component(s) 1304 may comprise volatile media (e.g., random access memory (RAM)) and/or nonvolatile media (e.g., read only memory (ROM), Flash memory, optical disks, magnetic disks and the like). The memory and/or storage component(s) 1304 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 1306 allow a user to enter commands and information to the computing device 1300, and also allow information to be presented to the user and/or other components or devices. Examples of input devices include a keyboard, a cursor control device (e.g., a mouse), a microphone, a scanner, biometric sensors, and the like. Examples of output devices include a display device (e.g., a monitor or projector, speakers, a printer, a network card, etc.). The computing device 1300 may comprise an alphanumeric keypad coupled to the processing unit 1302. The keypad may comprise, for example, a QWERTY key layout and an integrated number dial pad. The computing device 1300 may comprise a display coupled to the processing unit 1302. The display may comprise any suitable visual interface for displaying content to a user of the computing device 1300. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 1302 may be arranged to provide processing or computing resources to the computing device 1300. For example, the processing unit 1302 may be responsible for executing various software programs including system programs such as operating system (OS) and application programs. System programs generally may assist in the running of the computing device 1300 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, JavaOS, Android OS, Apple OS or other suitable OS in accordance with the described embodiments. The computing device 1300 may comprise other system programs such as device drivers, programming tools, utility programs, software libraries, application programming interfaces (APIs), and so forth.

The computing device 1300 also includes a network interface 1310 coupled to the bus 1308. The network interface 1310 provides a two-way data communication coupling to a local network 1312. For example, the network interface 1310 may be a digital subscriber line (DSL) modem, satellite dish, an integrated services digital network (ISDN) card or other data communication connection to a corresponding type of telephone line. As another example, the network interface 1310 may be a local area network (LAN) card effecting a data communication connection to a compatible LAN. Wireless communication means such as internal or external wireless modems may also be implemented.

In any such implementation, the network interface 1310 sends and receives electrical, electromagnetic or optical signals that carry digital data streams representing various types of information, such as the selection of goods to be purchased, the information for payment of the purchase, or the address for delivery of the goods. The network interface 1310 typically provides data communication through one or more networks to other data devices. For example, the network interface 1310 may effect a connection through the local network to an Internet Host Provider (ISP) or to data equipment operated by an ISP. The ISP in turn provides data communication services through the internet (or other packet-based wide area network). The local network and the internet both use electrical, electromagnetic or optical signals that carry digital data streams. The signals through the various networks and the signals on the network interface 1310, which carry the digital data to and from the computing device 1300, are exemplary forms of carrier waves transporting the information.

The computing device 1300 can send messages and receive data, including program code, through the network(s) and the network interface 1310. In the Internet example, a server might transmit a requested code for an application program through the internet, the ISP, the local network (the network 1312) and the network interface 1310. In accordance with the present disclosure, one such downloaded application provides for the identification and analysis of a prospect pool and analysis of marketing metrics. The received code may be executed by processing unit 1302 as it is received, and/or stored in storage device 1304, or other non-volatile storage for later execution. In this manner, computing device 1300 may obtain application code in the form of a carrier wave.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits ASICs, FPGAs, DSPs, or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, non-transitory medium, transmitting computer, receiving computer, etc. located outside the territory).

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Various aspects of the subject matter described herein are set out in the following numbered clauses:

1. A computer-implemented method for a track data point-of-sale platform, the method comprising: receiving a transaction request by a processor configured to process point-of-sale transactions, the transaction request comprising at least one parameter associated with a payment instrument configured for use in the point-of-sale transaction; identifying, by the processor, a transaction request type characterized by an identifier in the at least one parameters associated with the payment instrument; processing, by the processor, the transaction request according to the identified transaction request type; and generating, by the processor, a response to the transaction request.

2. The computer-implemented method of clause 1, wherein the at least one parameter associated with the payment instrument is formatted as track data.

3. The computer-implemented method of clause 2, wherein the identifier comprises a first predetermined number of characters stored in a track one data field.

4. The computer-implemented method of clause 2, wherein the identifier comprises a predetermined number of characters stored in a track two data field.

5. The computer-implemented method of clause 2, wherein a code representative of a currency value is stored in a track data field.

6. The computer-implemented method of clause 1, wherein the at least one parameter associated with the payment instrument is static.

7. The computer-implemented method of clause 1, wherein the at least one parameter associated with the payment instrument is stored in a magnetic stripe.

8. The computer-implemented method of clause 1, wherein the at least one parameter associated with the payment instrument is dynamically generated.

9. The computer-implemented method of clause 1 wherein the processor is further configured to execute a pre-commerce screening engine; and generating, by the processor, one or more targeted offers based on the at least one parameter associated with the payment instrument; processing, by the processor, the transaction request in conjunction with the one or more targeted offers; and generating, by the processor, the response to the transaction comprising a reduced authorization amount and the one or more targeted offers.

10. A computer-implemented method for a track data point-of-sale platform, the method comprising: receiving a transaction request by a first processor configured to process point-of-sale transactions, the transaction request comprising at least one parameter associated with a payment instrument configured for use in the point-of-sale transaction; identifying, by the first processor, a transaction request type characterized by an identifier in the at least one parameters associated with the payment instrument; transferring, by the first processor, a transaction request of a specified transaction request type to a second processor; processing, by the second processor, the transaction request according to the specified transaction request type; generating, by the second processor, a response to the transaction request; and transferring, by the second processor, the response to the first processor.

11. The computer-implemented method of clause 10, wherein the at least one parameter associated with the payment instrument is formatted as track data.

12. The computer-implemented method of clause 10, wherein the at least one parameter associated with the payment instrument is static.

13. The computer-implemented method of clause 12, wherein the at least one parameter associated with the payment instrument is stored in a magnetic stripe.

14. The computer-implemented method of clause 10, wherein the at least one parameter associated with the payment instrument is dynamically generated.

15. The computer-implemented method of clause 10, wherein the processor is further configured to execute a pre-commerce screening engine; and generating, by the processor, at least one targeted offer based on the at least one parameters associated with the payment instrument; processing, by the processor, the transaction request in conjunction with the one or more targeted offers; and generating, by the processor, the response to the transaction comprising a reduced authorization amount and the one or more targeted offers.

16. An apparatus comprising: a processor; and a memory unit operatively coupled to the processor, wherein the memory unit is configured to store a plurality of instructions, and wherein the plurality of instructions is configured to program the processor to execute point-of-sale transactions to: receive a transaction request and at least one parameter associated with a payment instrument; identify a transaction request type characterized by an identifier in the at least one parameters associated with the payment instrument; process the transaction request according to the identified transaction request type; and generate a response to the transaction request.

17. The apparatus of clause 16, wherein the at least one parameter associated with the payment instrument is formatted as track data.

18. The apparatus of clause 16, wherein the at least one parameter associated with the payment instrument is static.

19. The apparatus of clause 16, wherein the at least one parameter of the payment instrument is dynamically generated.

20. The apparatus of clause 16, wherein the memory unit is further configured with a plurality of instructions configured to program the processor to execute a pre-commerce screening engine; and generate at least one targeted offer based on the at least one parameter associated with the payment instrument.

What is claimed is:

1. A computer-implemented method for a track data point-of-sale platform, the method comprising:
receiving a transaction request by a processor configured to process point-of-sale transactions, the transaction request comprising at least one parameter associated with a payment instrument configured for use in the point-of-sale transaction;
identifying, by the processor, a transaction request type characterized by an identifier in the at least one parameters associated with the payment instrument;
processing, by the processor, the transaction request according to the identified transaction request type; and
generating, by the processor, a response to the transaction request.

2. The computer-implemented method of claim 1, wherein the at least one parameter associated with the payment instrument is formatted as track data.

3. The computer-implemented method of claim 2, wherein the identifier comprises a first predetermined number of characters stored in a track one data field.

4. The computer-implemented method of claim 2, wherein the identifier comprises a predetermined number of characters stored in a track two data field.

5. The computer-implemented method of claim 2, wherein a code representative of a currency value is stored in a track data field.

6. The computer-implemented method of claim 1, wherein the at least one parameter associated with the payment instrument is static.

7. The computer-implemented method of claim 1, wherein the at least one parameter associated with the payment instrument is stored in a magnetic stripe.

8. The computer-implemented method of claim 1, wherein the at least one parameter associated with the payment instrument is dynamically generated.

9. The computer-implemented method of claim 1, wherein the processor is further configured to execute a pre-commerce screening engine; and
generating, by the processor, one or more targeted offers based on the at least one parameter associated with the payment instrument;
processing, by the processor, the transaction request in conjunction with the one or more targeted offers; and
generating, by the processor, the response to the transaction comprising a reduced authorization amount and the one or more targeted offers.

10. A computer-implemented method for a track data point-of-sale platform, the method comprising:
receiving a transaction request by a first processor configured to process point-of-sale transactions, the transaction request comprising at least one parameter associated with a payment instrument configured for use in the point-of-sale transaction;
identifying, by the first processor, a transaction request type characterized by an identifier in the at least one parameters associated with the payment instrument;
transferring, by the first processor, a transaction request of a specified transaction request type to a second processor;
processing, by the second processor, the transaction request according to the specified transaction request type;
generating, by the second processor, a response to the transaction request; and
transferring, by the second processor, the response to the first processor.

11. The computer-implemented method of claim 10, wherein the at least one parameter associated with the payment instrument is formatted as track data.

12. The computer-implemented method of claim 10, wherein the at least one parameter associated with the payment instrument is static.

13. The computer-implemented method of claim 12, wherein the at least one parameter associated with the payment instrument is stored in a magnetic stripe.

14. The computer-implemented method of claim 10, wherein the at least one parameter associated with the payment instrument is dynamically generated.

15. The computer-implemented method of claim 10, wherein the processor is further configured to execute a pre-commerce screening engine; and
generating, by the processor, at least one targeted offer based on the at least one parameters associated with the payment instrument;
processing, by the processor, the transaction request in conjunction with the one or more targeted offers; and
generating, by the processor, the response to the transaction comprising a reduced authorization amount and the one or more targeted offers.

16. An apparatus comprising:
a processor; and
a memory unit operatively coupled to the processor, wherein the memory unit is configured to store a plurality of instructions, and wherein the plurality of instructions is configured to program the processor to execute point-of-sale transactions to:
receive a transaction request and at least one parameter associated with a payment instrument;
identify a transaction request type characterized by an identifier in the at least one parameters associated with the payment instrument;
process the transaction request according to the identified transaction request type; and
generate a response to the transaction request.

17. The apparatus of claim 16, wherein the at least one parameter associated with the payment instrument is formatted as track data.

18. The apparatus of claim 16, wherein the at least one parameter associated with the payment instrument is static.

19. The apparatus of claim 16, wherein the at least one parameter of the payment instrument is dynamically generated.

20. The apparatus of claim 16, wherein the memory unit is further configured with a plurality of instructions configured to program the processor to execute a pre-commerce screening engine; and generate at least one targeted offer based on the at least one parameter associated with the payment instrument.
